(19) United States
(12) Patent Application Publication
(10) Pub. No.: US 2019/0145361 A1
(43) Pub. Date: May 16, 2019

(54) DEVICE FOR OPTIMIZING THE COMBUSTION OF HYDROCARBONS

(71) Applicant: Miraglia Francesco, Genoa (IT)

(72) Inventor: Miraglia Francesco, Genoa (IT)

(21) Appl. No.: 16/158,145

(22) Filed: Oct. 11, 2018

(30) Foreign Application Priority Data
Nov. 14, 2017 (IT) 102017000129648

(51) Int. Cl. F02M 27/08; B06B 1/06; B06B 1/02

(52) U.S. Cl. CPC F02M 27/08; B06B 1/0207; B06B 1/0622

(57) ABSTRACT

A device is described, for optimizing the combustion of hydrocarbons, through induction of vibrations in the particles of fuel, comprising a tubular apparatus inserted in a fuel gas line, between a storage tank and an internal combustion engine; an ultrasound generator comprises a plurality of ultrasound piezoelectric transducers arranged on the tubular apparatus comprised of an internal tube coaxial with respect to an external tube, which supports the piezoelectric transducers, while the internal tube is composed of a series of tube sections made of ferromagnetic material arranged axially with interposed disks made of soft iron.

### CROSS-REFERENCE TO RELATED APPLICATIONS

The present Application is a national stage application of, and claims priority from, Italian Patent Application No. IT 102017000129648 filed 14 Nov. 2017, titled “DEVICE FOR OPTIMIZING THE COMBUSTION OF HYDROCARBONS,” the contents of which are incorporated in this disclosure by reference in their entirety.

### BACKGROUND OF THE INVENTION

### 1) Field of the Invention

The present invention refers to a device for optimizing the combustion of hydrocarbons.

In particular, the present invention refers to apparatuses for treating mixtures of combustion air, fuel or fuel-air, through catalysts, electric means, magnetism, rays, sound waves or the like, for ionization or polarization.

### 2) Background Art

The prior art is given by patent application US 2005/0208442 A1 dealing which a plasma jet reactor wherein a mixture of gases composed of N2 and O2 flows through a tube and enters in a microwave field. A generator produces microwaves supplied in a wave-guide and reflected at the other end of the wave-guide. The combustion chamber is preferably composed of a cylinder and of a piston of the engine which can move to transmit energy. The internal combustion engine comprises a first electrode and a second electrode, preferably formed of a ground drive cylinder. In an embodiment, an opposite electrode surrounds and coats a glass cylinder composed of insulating material. The inside of the cylinder forms the combustion chamber for the flame. The cylinder is preferably a quartz tube. The flame absorbs the electric charge through the quartz, so that a reactive capacitive current can flow due to the alternate electric field. If the voltage generator applies a continuous voltage to the electrodes, a small current is also formed.

The prior art is also given by patent U.S. Pat. No. 6,802,706, dealing with a device and a method of use of a magnetic field, advantageously of the pulsed type, generated next to a supplying tube for fuel. The interaction of the pulsating magnetic field with the drops of fuel induces vibrations in the individual drops of fuel, allowing to reduce the skin tension in every drop of fuel, which is thereby segmented into a multitude of micro-drops, generating a turbulence at microscopic level. In this way, the molecules of hydrocarbons, entering at a certain speed depending on suction, are rotated onto themselves and along opposite directions, each one with respect to another, allowing to obtain the two desired effects: weakening of the surface tension, breakage of the drops divided into micro-drops and forming the turbulence, according to angular speeds which allow optimizing the interaction of the hydrocarbons with oxygen of air inserted through the supplying tube.

The prior art is also given by patent U.S. Pat. No. 8,025,044, dealing with an apparatus for increasing the yield as travelled distance through an internal combustion engine. The apparatus is composed of a tube inserted in a fuel line between a storage tank and the engine, the tube having a plurality of electrodes projecting in a passage of fuel inside the tube. The electrodes are equipped with an electric charge for the transmission of electric charges to molecules of liquid fuel which flow through the passage of fuel of the tube. The tube inserted in a fuel line between a storage tank and an internal combustion engine comprises a plurality of electrodes projecting in a fuel passage inside the tube, the electrodes equipped with an electric charge to impart electric charges to molecules of liquid fuel which flow through the fuel passage along the tube, the electrodes arranged in four rows parallel to a longitudinal axis of the tube and in ten circumferential columns around the tube, the electrodes adjacent along a certain row being provided with electric charges of an alternate polarity.

In spite of these efforts, there remain the need of using alternative devices to improve and optimize the combustion of hydrocarbons.

### SUMMARY OF THE INVENTION

Object of the present invention is solving the above prior art problems by providing a device for optimizing the combustion of hydrocarbons through the fragmentation of the fuel particles which allows neutralizing the surface tension of drops of fluid.

A further object of the present invention is providing a device for optimizing the combustion of hydrocarbons which allows creating an ultrasound field wherein the flow of fuel fluid is immersed.

Another object of the present invention is providing a device for optimizing the combustion of hydrocarbons which allows coupling an ultrasound field with an axial-symmetric magnetic field to increase the impact of a field of various forces as regards the fluid flow of fuel.

The above and other objects and advantages of the invention, as will appear from the following description, are obtained with a device for optimizing the combustion of hydrocarbons come as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes arrangements and parts with equivalent functionality) can be made to what is described without departing from the scope of the invention as appears from the enclosed claims.

### BRIEF DESCRIPTION OF THE DRAWINGS

The present invention will be better described by some preferred embodiments thereof, provided as a non-limiting example, with reference to the enclosed drawings, in which:

FIG. 1 shows a schematic view of a preferred embodiment of the device for optimizing the combustion of hydrocarbons, according to the present invention;

FIG. 2 shows a plan view of a first meaningful part of the device for optimizing the combustion of hydrocarbons according to the present invention;

FIG. 3 shows a sectional view along line of the previous Figure;

FIGS. 4, 5 and 6 show orthogonal projection views and an axonometric view of a second meaningful part of the device for optimizing the combustion of hydrocarbons according to the present invention;

FIG. 7 shows a front view of a transducer used in the device for optimizing the combustion of hydrocarbons according to the present invention; and

FIG. 8 shows an exploded front view of a third meaningful part of the device for optimizing the combustion of hydrocarbons according to the present invention.

### DETAILED DESCRIPTION OF PREFERRED EMBODIMENTS

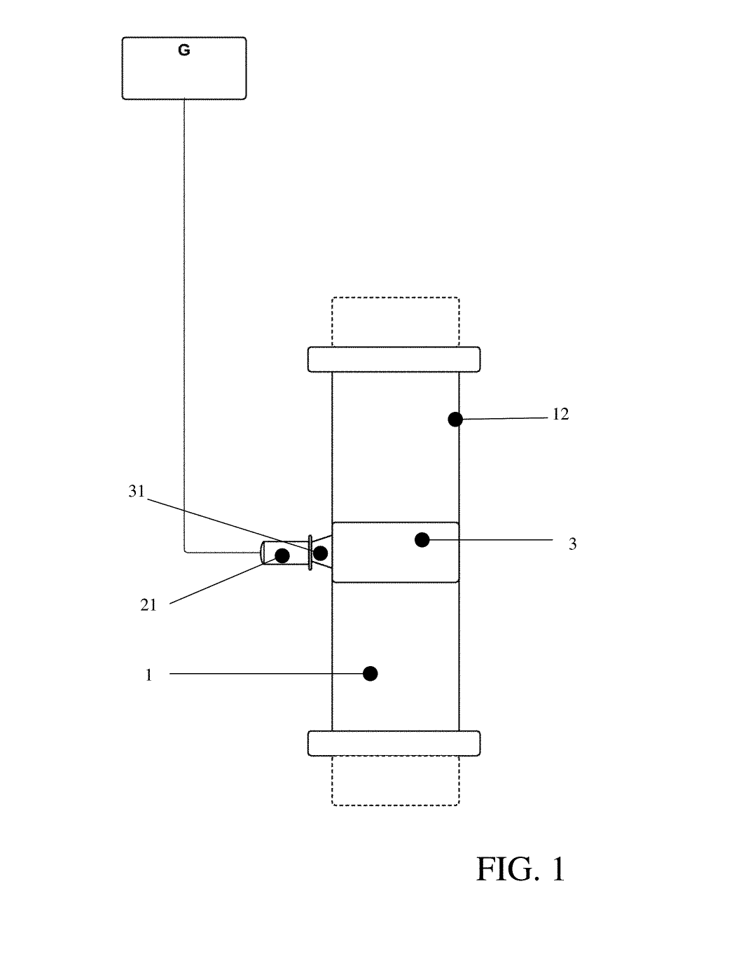

With reference to FIG. 1, it is possible to note that a device for optimizing the combustion of hydrocarbons, through induction of vibrations in the particles of fuel, comprises at least one tubular apparatus 1 inserted in a fuel gas line, between at least one storage tank and at least one internal combustion engine.

Advantageously, the device comprises at least one ultrasound generator G to supply a plurality of ultrasound piezoelectric transducers 21 arranged on the tubular apparatus 1.

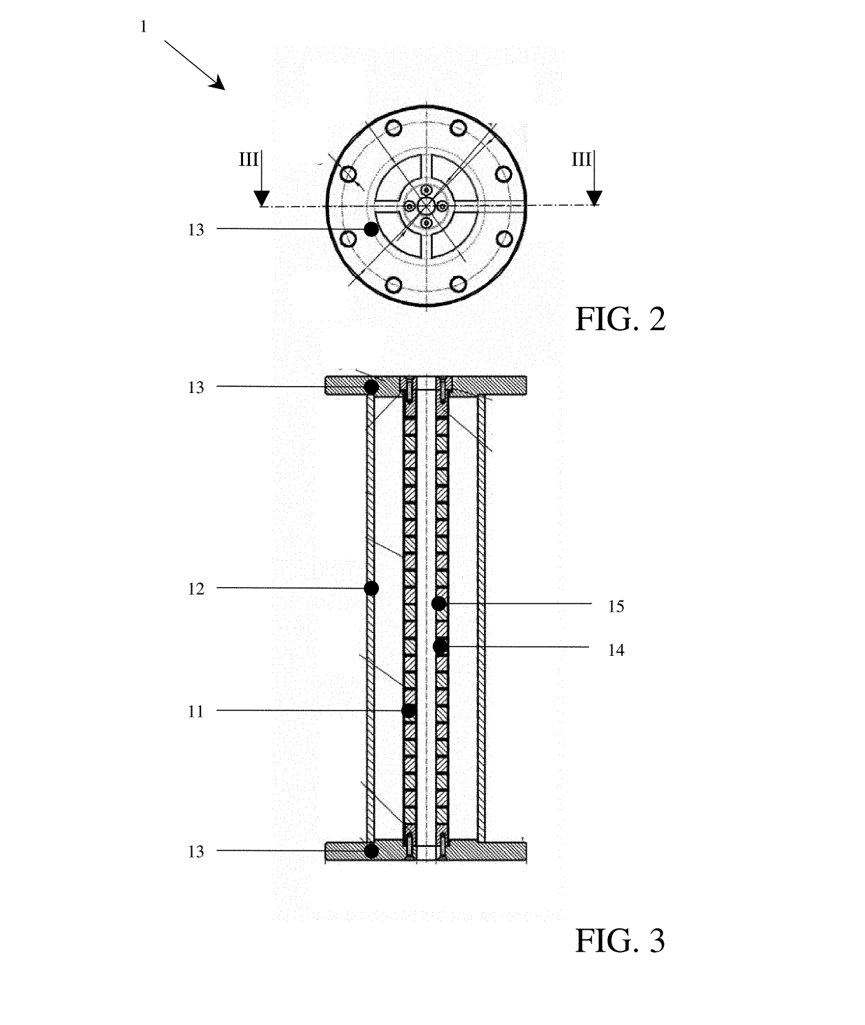

With reference to FIGS. 2 and 3, it is possible to note that the tubular apparatus 1 is composed of an internal tube 11 coaxial with respect to an external tube 12. The ends of the internal tube 11 and those of the external tube 12 are delimited by a pair of transverse holed flanges 13. The external tube 12 supports the plurality of ultrasound piezoelectric transducers 21.

In particular, the internal tube 11 is composed of a series of tube sections 14 made of ferromagnetic material arranged axially with interposed disks 15 made of soft iron. Preferably, the external tube 12 and the pair of transverse holed flanges 13 are made of stainless steel.

The plurality of ultrasound piezoelectric transducers 21 comprises at least one ultrasound piezoelectric transducer approximately oriented towards the center of the tubular apparatus 1, through an annular band 3 made roof stainless steel applied to the tubular apparatus 1.

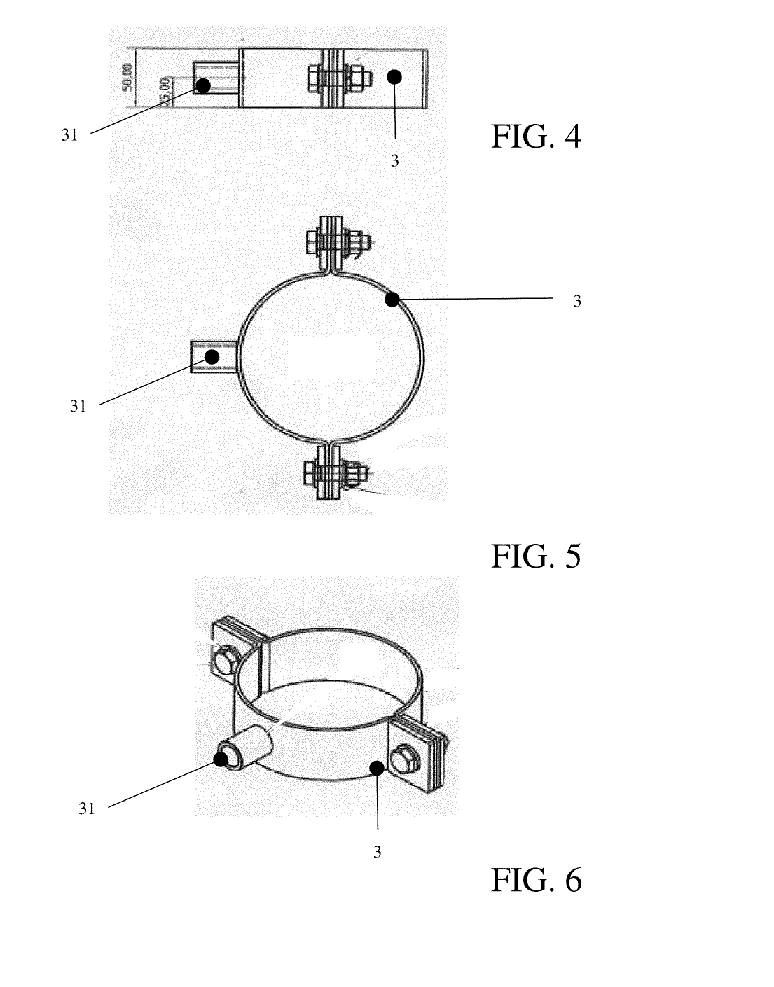

With reference to FIGS. 4 to 6, each ultrasound piezoelectric transducer belonging to the plurality of ultrasound piezoelectric transducers 21 is connected to its respective annular band 3 through a NPT ½″ sleeve 31 made of stainless steel and equipped with a hole with gas threading to block the respective ultrasound piezoelectric transducer 21 and welded to the respective annular band 3.

According to a preferred configuration, not shown, the plurality of ultrasound piezoelectric transducers 21 is formed of six ultrasound piezoelectric transducers arranged along the tubular apparatus 1 and offset on the circumference of the tubular apparatus 1.

From a dimensional point of view, the device for optimizing the combustion of hydrocarbons is preferably composed of a tubular apparatus 1 composed of an internal tube DN80 and an external tube DN125.

Moreover, the ultrasound generator G supplies each ultrasound piezoelectric transducer of the plurality of ultrasound piezoelectric transducers 21 with a 250V electric voltage, at a frequency of 22.5 kHz, for a 50 W electric power at 0.200 A, for a total of 300 W and 1.2 A.

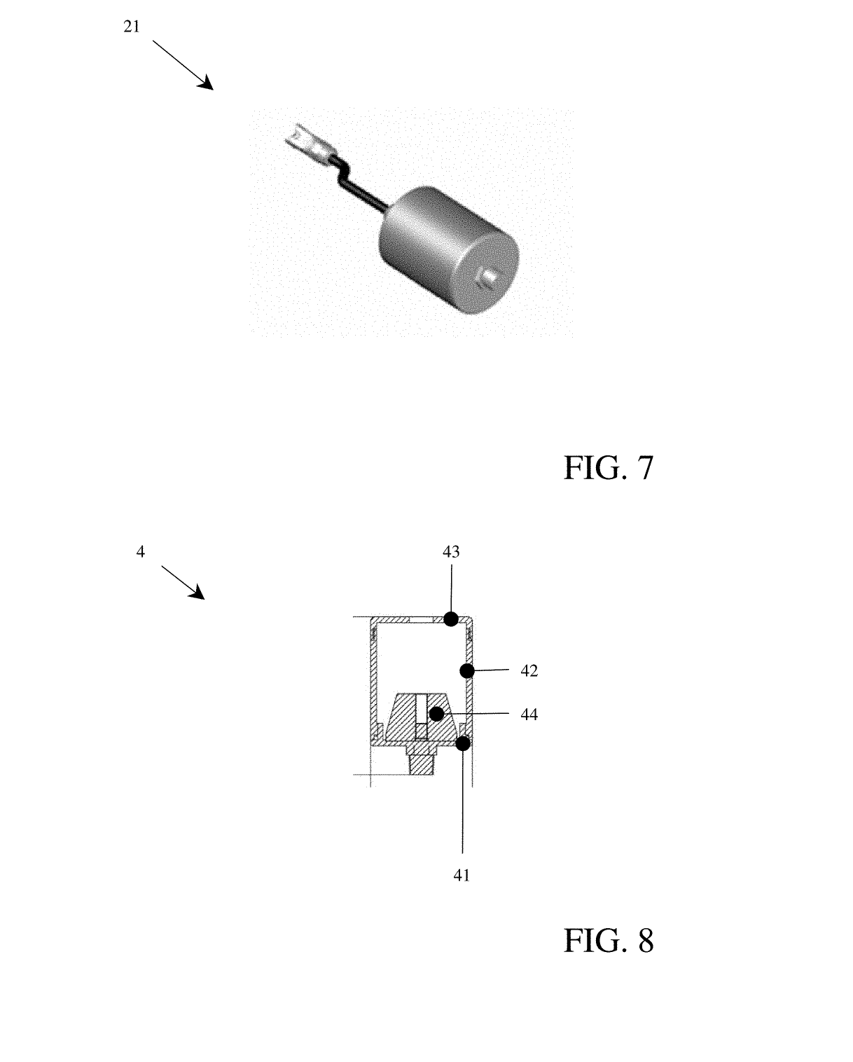

With reference to FIG. 8, it is possible to note that each ultrasound piezoelectric transducer, like the one shown in FIG. 7, of the plurality of ultrasound piezoelectric transducers 21 is housed in an extension room 4. The extension room 4 is formed of a base 41, an annular wall 42, a holed cover 43 and is equipped therein with a tapered holed head 44.

The device for optimizing the combustion of hydrocarbons of the present invention allows thereby reaching the stated objects.

Mainly, such device allows treating the fuel by reducing the molecular tension of any fuel which crosses it.

The smallest fuel particles are permanently generated in the fuel supply system, allowing to increase the fuel surface in contact with air inside the combustion chamber.

The effects induced by the device for optimizing the combustion of hydrocarbons are: higher efficiency of the combustion process; average reduction equal to 1% of the fuel consumption, reduction of CO; reduction of the generated PM; greater cleaning of hot components in the diesel engine, of the turbine blades in the turbo-compressor, of the detergent in the economizing device.

The device for optimizing the combustion of hydrocarbons only treats the fuel, reducing the molecular tension upon its passage and allowing a bigger amount of O2 to take part in the combustion, in order to burn the higher amount of available fuel, with a reduction of free O2, reduction of the fuel consumption, reduction of solid parts in the atmosphere.

The device for optimizing the combustion of hydrocarbons has no moving parts and can be installed in any position. The piezoelectric transducers are applied outside the tube and have no direct contact with the fuel. According to a preferred configuration, the device for optimizing the combustion of hydrocarbons is composed of:

1 device Series OEYK5R0004 with permanent magnets and ultrasound piezoelectric transducers;

4 flanges, two on each side, INOX 316 L-PN16-DN125;

4 flange, two on each side, INOX 316 L-PN16-DN80;

2 concentric reductions INOX 316 DN125-DN80, one on each side;

1 electric panel and ultrasound generator, 600×600×250 mm, to supply 6 piezoelectric transducers LEO 50.

The electric panel and the ultrasound generator are composed of:

1 metallic cabinet—Ral 6034;

1 ultrasound generator IKE 2200 AS 6;

1 document-holder;

1 door lock, Mod. Rittal 2519.000;

1 contact circuit without potential for the remote signal;

1 general switch;

1 ammeter;

1 meter;

4 alarm LEDs;

1 main switch holder block;

1 fan suction filter;

2 cooling fans;

6 switches for controlling the transducer, with all-on signal;

protection with automatic switches.

The ultrasound generator is equipped with two alarms: common alarm; ultrasound generator alarm.

ULTRASONIC TRANSDUCERS ALARM mode, to manually determine which transducer is malfunctioning, deactivating the switch of individual transducers till the alarm stops.

To determine the non-operating transducer, it is necessary to turn the selectors off till the alarm stops.

The generator is automatically started.

The operator must replace the faulty transducer without opening the electric panel.

1-9. (canceled)

10. A device for optimizing the combustion of hydrocarbons, the device comprising:
a) at least one tubular apparatus designed to be inserted in a fuel gas line, between at least one storage tank and at least one internal combustion engine; and
b) at least one ultrasound generator to supply a plurality of ultrasound piezoelectric transducers arranged on the tubular apparatus to induce vibrations in fuel particles.

11. The device of claim 10, wherein the tubular apparatus comprises an internal tube coaxial and an external tube, wherein the ends of the internal tube and the external tube are delimited by a pair of transverse holed flanges.

12. The device of claim 11, wherein the external tube is adapted to support the plurality of ultrasound piezoelectric transducers.

13. The device of claim 11, wherein the internal tube comprises a series of tube sections made of ferromagnetic material arranged axially with interposed disks made of soft iron, the external tube and the pair of transverse holed flanges being made of stainless steel.

14. The device of claim 10, wherein the at least one tubular apparatus is comprised of an internal tube DN80 and an external tube DN125.

15. The device of claim 10, wherein the plurality of ultrasound piezoelectric transducers comprise at least one ultrasound piezoelectric transducer oriented approximately towards the center of the tubular apparatus, through an annular band made of stainless steel applied to the tubular apparatus.

16. The device of claim 15, wherein the at least one ultrasound piezoelectric transducer of the plurality of ultrasound piezoelectric transducers is connected to its respective annular band through a one half inch (½″) American National Standard Pipe Thread (NPT) sleeve made of stainless steel equipped with hole with gas threading to block the respective ultrasound piezoelectric transducer and welded to the respective annular band.

17. The device of claim 10, wherein the plurality of ultrasound piezoelectric transducers comprises six ultrasound piezoelectric transducers arranged along the tubular apparatus and offset on the circumference of the tubular apparatus.

18. The device of claim 10, wherein the ultrasound generator supplies each ultrasound piezoelectric transducer with a 250V electric voltage, at a frequency of 22.5 kHz, for a 50 W electric power at 0.200 A, for a total of 300 W and 1.2 A.

19. The device of claim 10, wherein each ultrasound piezoelectric transducer is housed in an extension room, the extension room being formed of a base, an annular wall, a holed cover comprising a tapered holed head.
